(19) United States
(12) Patent Application Publication
(10) Pub. No.: US 2009/0084067 A1
(43) Pub. Date: Apr. 2, 2009

(54) METHOD OF RETROFITTING OVERHANG AREAS OF ROOF STRUCTURES

(76) Inventor: Robert E. PLATTS, Ottawa (CA)

Correspondence Address: OGILVY RENAULT LLP, 1981 MCGILL COLLEGE AVENUE, SUITE 1600, MONTREAL, QC, H3A2Y3, CA

(21) Appl. No.: 12/243,466

(22) Filed: Oct. 1, 2008

Related U.S. Application Data
(60) Provisional application No. 60/976,875, filed on Oct. 2, 2007.

(51) Int. Cl. E04B 7/00; E04D 13/00; B29C 65/52

(52) U.S. Cl. 52/745.21; 29/402.18; 156/71; 156/60

(57) ABSTRACT

A method of retrofitting an overhang area of a roof structure of a building comprises spraying an adhesive material to a soffit to secure the soffit to a wall and/or the roof structure. The adhesive material may be further applied to seal the perforations of the soffits.

### CROSS-REFERENCE TO RELATED APPLICATIONS

This is based on and claims benefit of priority of U.S. Provisional Application Ser. No. 60/976,875 filed on Oct. 2, 2007.

### TECHNICAL FIELD

The concept relates to roof structures of buildings, and more particularly relates to a method of retrofitting an overhang area of a roof structure of a building.

### BACKGROUND OF THE ART

Modern houses in the US hurricane belt, as elsewhere, are commonly fitted with light weight continuously perforated aluminium soffit panels at overhang areas of the roof structures, and indeed most older houses have been retrofitted likewise. These perforated soffit panels are relatively maintenance-free, attractive and amply vented. Unfortunately, however, the perforated soffit panels are usually not adequately secured and tend to blow off in hurricane force winds, becoming missiles that can smash into nearby windows (even if these are at some distance) and creating a hazard to any people or objects in their path. Unfortunately too, even where such soffit panels stay in place, hurricane force winds can drive rain through the soffit panels, ruinously carrying the moisture on air streams blowing into the roof space and dropping it on the ceiling and upper wall/window areas.

Removing the perforated soffit panels and replacing them with solid panels is a slow and costly solution. Gutters/downspouts and fascias must generally be disrupted and removed first, often being damaged in the process, and new support strips are needed at the house wall and sometimes at the sub-fascia. Furthermore, venting issues and associated rain control problems must still be addressed separately.

Therefore, there is a need for an improved method of retrofitting an overhang area of a roof structure against hurricane force winds and/or rain.

### SUMMARY

In accordance with one aspect of the concept, there is provided a method of retrofitting an overhang area of a roof structure of a building which comprises: a) inserting a spray tool into a space between a roof sheathing and a soffit in the overhang area of the roof structure; then b) spraying an adhesive material atop the soffit against a vertical surface of a support member, connecting an outer end of the soffit, to form a fillet of the adhesive material abutting both the soffit and the vertical surface; and c) spraying the adhesive material atop the soffit against a wall of the building which supports an inner end of the soffit, to form a fillet of the adhesive material abutting both the soffit and the wall.

In accordance with another aspect of the concept, there is a method of retrofitting an overhang area of a roof structure of a building which comprises: (a) applying an adhesive coating over an under surface of a soffit in the overhang area of the roof structure to cover perforations and joints of the soffit and (b) applying the adhesive coating to the under surface at an inner end of the soffit against a wall of the building which supports the soffit, to form a fillet of the adhesive coating in order to secure the soffit to the wall.

These aspects and other advantages of the concept will be better understood with reference to the embodiments described below with reference to the accompanying drawings.

### BRIEF DESCRIPTION OF THE DRAWINGS

Reference will now be made to the accompanying drawings depicting the embodiments by way of illustration in which:

FIG. 1 is a cross-sectional view of an overhang area of a roof structure of a building with a perforated soffit, shown in a retrofitting process according to one embodiment;

FIG. 2 is an elevational illustration of the overhang area of the roof structure, showing use of a spraying tool to spray a gap-filling adhesive coating to seal the soffit perforations and joints from below according to another embodiment; and

FIG. 3 is a cross-sectional view of the overhang area of the roof structure indicated by numeral 3 in FIG. 2, showing a further step in the retrofitting process according to another embodiment.

### DETAILED DESCRIPTION OF THE EMBODIMENTS

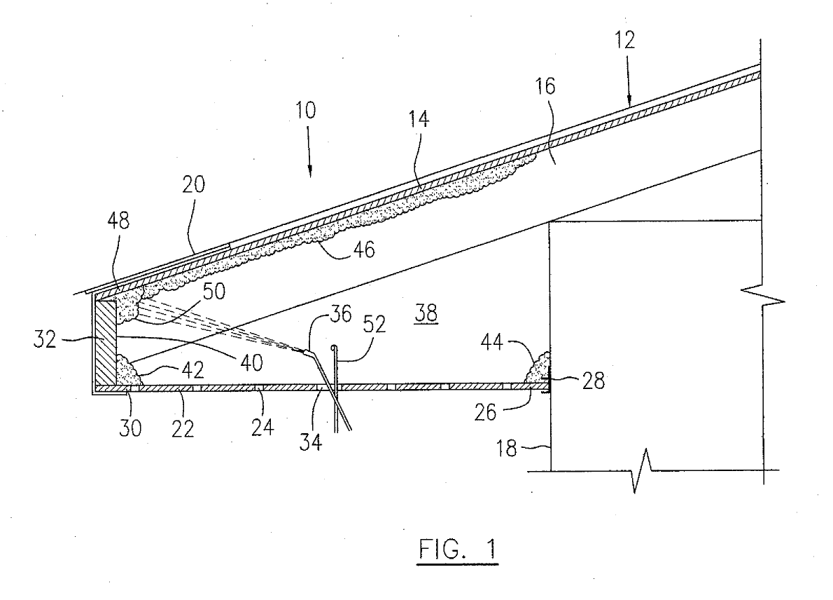

FIG. 1 illustrates an overhang area 10 of an existing roof structure 12 of a building, in which a roof sheathing 14 is secured to and supported by a plurality of roof frames 16 (only one shown) which is in turn supported by a wall 18 of the building and other support structures (not shown) of the building. The roof sheathing 14 and the roof frames 16 extend outwardly from the wall 18 to form an overhang configuration of the building. Shingles 20 or other roof finishing materials are placed on the top of the roof sheathing and are secured thereto. A soffit 22 with perforations 24 is placed in a substantially horizontal orientation (as typically done) in the overhang area 10. The soffit 22 is supported at the inner end 26 on the wall 18, for example by a plurality of “J-channel” connectors 28 which provide a somewhat flimsy support for the soffit 22. An outer end 30 of the soffit 22 is connected to and supported by a support component such as a sub-fascia 32 which in turn is affixed to the outer ends of the roof frames 16. The soffit 22 includes a plurality of perforated soffit panels which may comprise various patterns. For convenience of description and clarification of illustration, soffit 22 is illustrated as being formed by flat perforated panels.

It has been realized that the attachment of the soffit 22 to the sub-fascia 32 and the wall 18 is inadequate and therefore a retrofitting process according to one embodiment is provided.

At least one opening 34 is made through the soffit to allow a spray tool such as a spray gun 36 to be inserted therethrough into the space 38 between the roof sheathing 14 and the soffit 22 in the overhang area 10, in order to spray an adhesive material (for example a two-part, two-PCF polyurethane foam) atop the soffit 22 at the outer end 30 against a vertical surface 40 of the sub-fascia 32, to form a filet 42 abutting both the soffit 22 and the vertical surface 40 of the sub-fascia 32. The fillet 42 of the adhesive material adheres well even to dusty surfaces and cures to more than adequate strength and stiffness.

Similarly, the adhesive material can be sprayed atop the soffit 22 at the inner end 26 against the wall 18 to form a fillet 44 abutting both the soffit 22 and the wall 18. The fillets 42 and 44 can permanently secure the soffit 22 to the respective sub-fascia 32 and wall 18 against both upward and downward wind forces while sealing against wind and rain entry along the soffit edges at both inner and outer ends 26, 30.

The spray process according to one embodiment may be further applied to reinforce the attachment of roof sheathing 14 to the roof frames 16. The adhesive material is sprayed to an under surface of the roof sheathing 14 against at least one side (or alternatively both sides) of a roof frame 16 in order to form a fillet 46 of the adhesive material along a junction area between the sheathing 14 and the roof frame 16 within the overhang area 10 of the roof structure. The fillet(s) 46, on one or both sides of such roof frame 16, further secure the sheathing 14 to the roof frame 16 against wind uplift forces that tend to be extreme in this overhang area 10. The adhesive material may also be sprayed to the under surface of an outer end 48 of the of the roof sheathing 14, against the vertical surface 40 of the sub-fascia 32 in order to form a fillet 50 along a junction area between the outer end 48 of the roof sheathing 14 and the vertical surface 40, against the strong wind uplift forces.

Opening 34 is located in the soffit 22 and provides a convenient access for the spray gun 36 to enter into the space 38 within the overhang area 10 for the spraying operation. According to one embodiment, a plurality of openings 34 may be drilled through the soffit 22, for example 16 or 24 inches apart along the length of the soffit 22 (perpendicular to the paper of the drawing), one opening 34 for every “truss” space, “rafter” space (“truss space” or “rafter space”) which is a space between two adjacent roof frames 16, to allow adequate spraying and inspection access with those spaced apart openings 34. It is possible to conduct the spraying operation along a selected or entire length of a junction area between the outer end 30 of the soffit 22 and the vertical surface 40, between the inner end 26 of the soffit 22 and the wall 18, and between the outer end 48 of the roof sheathing 14 and the vertical surface 40 in order to form the respective fillets 42, 44, 48 and 50 of the adhesive material. It is also possible to conduct the spraying operation along the roof junctions within the overhang area 10 between the sheathing 14 and all the roof frames 16.

The operation may be guided and inspected by means of an optical fiber scope 52. The optical fiber scope 52 includes a fish-eye lens offering almost infinite “depth of field” viewing.

According to a further embodiment, the same access points of openings 34 may be used to further conduct a perforation-sealing and joint-sealing process by using the spray gun 36 or similar spray tool to apply an adhesive coating over the entire upper surface of the soffit 22. The spray gun 36 or similar spray tool and the optical fiber scope 52 are withdrawn from the openings 34 when the spraying operation is complete. The openings 34 are then finally sealed from the under side of the soffit 22 by application of adhesive coating to the under side of the soffit 22. Therefore, the soffit 22 is adequately secured against hurricane wind pressures and sealed against wind born rain entry.

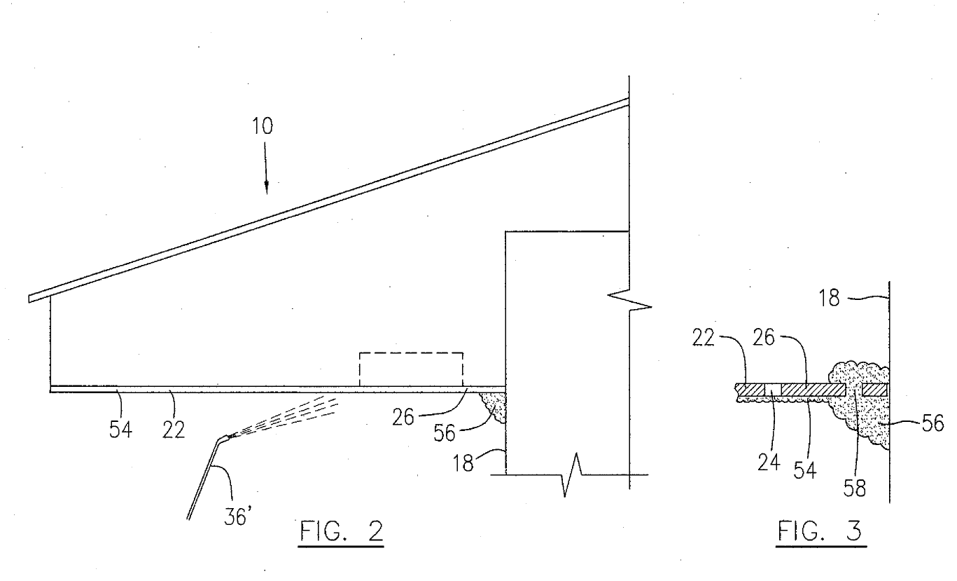

FIG. 2 illustrates another embodiment in which an adhesive coating layer 54 is applied from below over an entire under surface of the soffit 22 to cover the perforations 24 as well as joints between adjoining soffit panels (not shown), against wind born rain entry into the overhang area 20 of the roof structure. This process is conducted by a spray tool 36′ which may be similar to or different from the spray gun 36 used in the embodiment shown in FIG. 1. The adhesive coating is further applied to the under surface of the soffit 22 at the inner end 26 against the wall 18 to form a fillet 56 to secure the inner end 26 of the soffit 22 to the wall 18. The fillet 56 of the adhesive coating, may be made to extend along a selected or along the entire length of a junction area between an inner end 26 of the soffit 22 and the wall 18. The coating application process may be preceded by a pressure-blowing or by wiping clean the entire soffit under-surface including where its ribs (not shown) extend under the sub-fascia 32 and the J-channel connectors 28 (as shown in FIG. 1), to ensure best possible adhesion. The sealing coating material may be selected from a higher density foam polyurethane, such as a formulation already developed for lining the beds of pick-up trucks, to readily form a pleasing stucco-like or leather-like appearance, for example. The coating layer 54 also extends between the sub-fascia 32 and soffit 22 and between the J-channel connectors 28 and the soffit 22, or even further extends between the sub-fascia 32 and the fascia and between the J-channel connectors 28 and the wall 18 (see FIG. 1), according to the embodiment, greatly reinforcing the soffit against wind pressure differentials. The embodiment illustrated in FIG. 2 which avoids the need to work within the soffit space by being an external operation conducted outside of the overhang area of the roof structure, is more convenient and simpler than a rigorous operation inside of the overhang area 10 of the roof structure as shown in FIG. 1. This “from below” process can be especially advantageous where the space above the soffit is constricted, such as in the not uncommon case (not shown) where the soffit is applied directly to the underside of the sloped roof frame overhangs.

However, the external operation illustrated in FIG. 2 may be incorporated into the embodiment shown in FIG. 1 to provide a most rigorous procedure for retrofitting the overhang area of the roof structure. Of course, the external operation of FIG. 2 will begin after completion of the internal operation of FIG. 1.

FIG. 3 illustrates a further embodiment in which, when the external operation as shown in FIG. 2 is independent from the internal operations as shown in FIG. 1 and there is a need for further securing of the soffit 22, a plurality of closely-spaced holes 58 may be drilled through the soffit 22 along the junction area between the inner end 26 of the soffit 22 and the wall 18, to allow a portion of the fillet 56 to enter into each of the holes 58 to contact both a top surface of the soffit 22 and a portion of the wall 18 above the soffit 22 during formation of the fillet 56 under the soffit 22. Portions of the fillet 56 expand above the soffit 22 to better secure the soffit 22 against upward movement.

In FIG. 2, a box shown in dashed lines represents an optional vent device inserted through the soffit 22. Such vents can be rain controlling and even pressure controlling devices, for example such as that described in Applicant's U.S. Pat. No. 6,484,459 which is incorporated herein by reference, thereby meeting the objective of keeping the soffits on and the wind out when the perforated soffit is sealed and held secure, as above described. Vent openings for the vent devices should be made in the soffit 22 first and thus can also provide alternative access ports for the internal operations illustrated in FIG. 1. The vent devices can then be installed after completion of the internal operations.

The above description is meant to be exemplary only, and one skilled in the art will recognize that changes may be made to the embodiments described without departure from the scope of the described concept. Modifications which fall within the scope of the concept will be apparent to those skilled in the art in light of a review of this disclosure, and such modifications are intended to fall within the scope of the appended claims.

I claim:

1. A method of retrofitting an overhang area of a roof structure building, comprising:
a) inserting a spray tool into a space between a roof sheathing and a soffit in the overhang area of the roof structure; then
b) spraying an adhesive material atop the soffit against a vertical surface of a support member connecting an outer end of the soffit, to form a fillet of the adhesive material abutting both the soffit and the vertical surface; and
c) spraying the adhesive material atop the soffit against a wall of the building which supports an inner end of the soffit, to form a fillet of the adhesive material abutting both the soffit and the wall.

2. The method as defined in claim 1 wherein step (b) is conducted along a length of a junction area between the outer end of the soffit and the vertical surface.

3. The method as defined in claim 1 wherein step (c) is conducted along a length of a junction area between the inner end of the soffit and the wall of the building.

4. The method as defined in claim 1 comprising a further step conducted after step (a), of spraying the adhesive material onto an under surface of a roof sheathing against the vertical wall, to form a fillet of the adhesive material extending along a junction area between an outer end of the roof sheathing and the vertical surface.

5. The method as defined in claim 1 comprising a further step conducted after step (a), of spraying the adhesive material onto an under surface of a roof sheathing against at least one side of a roof frame which supports the roof sheathing, forming a fillet of the adhesive material extending along a junction area between the sheathing and the roof frame within the overhang area of the roof structure.

6. The method as defined in claim 1 comprising a further step conducted prior to step (a), of making at least one opening through the soffit to provide an access for the spray tool to be inserted into the space within the overhang area of the roof structure.

7. The method as defined in claim 1 wherein the adhesive material comprises a polyurethane foam.

8. The method as defined in claim 1 comprising inserting an optical fiberscope into the space within the overhand area of the roof structure to inspect the operation and the results of the spraying.

9. The method as defined in claim 1 further comprising a step of spraying an adhesive coating to cover perforations and joints of the soffit.

10. The method as defined in claim 9 wherein the step of spraying the adhesive coating is conducted after completion of steps (a), (b) and (c).

11. The method as defined in claim 10 wherein spraying of the adhesive coating is applied to an under surface of the soffit.

12. A method of retrofitting an overhang area of a roof structure of a building, comprising: (a) applying an adhesive coating over an under surface of a soffit in the overhang area of the roof structure to cover perforations and joints of the soffit and (b) applying the adhesive coating to the under surface at an inner end of the soffit against a wall which supports the soffit, to form a fillet of the adhesive coating in order to secure the soffit to the wall.

13. The method as defined in claim 12 wherein the fillet extends along a length of a junction area between the inner end of the soffit and the wall.

14. The method as defined in claim 13 comprising a further step conducted prior to step (b), of making a plurality of holes through the soffit near the wall to allow a portion of the fillet of the adhesive coating to enter into each of the holes in order to contact both a top surface of the soffit and a portion of the wall above the soffit.
